(19) United States
(12) Patent Application Publication
(10) Pub. No.: US 2008/0134942 A1
(43) Pub. Date: Jun. 12, 2008

(54) Carbon Nanotube-Fiber Reinforced Cement And Concrete

(76) Inventors: Matthew Brenner, Plano, TX (US); Arjun Mariputtana Kavi, Plano, TX (US); Michael Guan-Yu Li, Plano, TX (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/609,620

(22) Filed: Dec. 12, 2006

(51) Int. Cl. C04B 16/12; C04B 7/02

(52) U.S. Cl. 106/672

(57) ABSTRACT

Carbon nanotubes (CNTs) are combined with cement, aggregate and plasticizers to form composites with increased strength. CNT reinforced concretes comprising cement, plasticizer, aggregate, and nanotubes, hydrated with water are disclosed. A mixture of CNTs, cement, and plasticizer can be prepared for later admixture with aggregates and water to form composites having improved strength characteristics. A method for increasing the strength of concrete comprising the steps of admixing CNTs and plasticizer's with cement, aggregate, and water for hydration is also disclosed.

### FIELD OF THE INVENTION

As recent events such as the disastrous failure of levees during Hurricane Katrina show, there is a modern need for concretes and other composites of greater strength. In particular, it would be desirable to increase the strength of the concrete in both tension as well as in compression. While steel rebar has been used for many years to increase the strength of concrete, there is a need for better composite materials.

Among those which have been discovered are glass fiber reinforced concrete (GFRC). GFRCs employ thin layers of a synthetic glass fiber material more commonly known as Fiberglass to reduce the size of the reinforcement members without reducing their individual tensile strength. In addition, steel fiber reinforced concrete is known. For these materials, small threads or even woven sheets of stainless steel are used for reinforcement.

Carbon nanotubes are relatively new materials and have garnered much recent attention. There are two basic types of nanotubes. The first are single-wall nanotubes, or SWCNTs. Also known are multi-wall nanotubes or MWCNTs. which are known to have at least two different sub-types. For the purpose of this invention, the term “CNT” is defined as including both types, namely SWCNTs, and MWCNTs.

Regardless of their specific structure, all nanotubes share a great deal of interesting and unique properties. Perhaps first among these is their remarkable strength. Due to their molecular construction, each bond in a nanotube is an SP² orbital bond, which results from the hybridization of an s oribital with two p orbitals and which is among the strongest possible chemical bonds. Because of this fact, the carbon nanotube is among the strongest substances known to man in terms of tensile strength. A nanotube was measured to have a tensile strength of 63 GPa. This can be compared to high carbon steel which has a tensile strength of around 3.1 GPa.

### PRIOR ART

Researchers in Canada have published a study regarding the possible use of carbon nanotubes in cement composites. See, Carbon Nanotubes/Cement Composites—Early Results And Potential Applications, Jon Makar, Jim Margeson and Geanne Luh, National Research Council, Canada. These researchers used CNT/Cement in a ratio of about 0.02% by weight. CNT's were added directly to Portland cement, apparently without additional aggregate. Mixes were made at various water/cement ratios and with and without superplasticizer. The Canadian researchers concluded from their testing and SEM imaging that particles of powdered hydrated cement were being held together by CNT bundles. The group apparently did not test, nor suggest, the use of specific amounts of CNTs or plasticizers in connection with a cement composite that includes both an aggregate, such as sand, the CNTs and Portland cement.

### SUMMARY OF THE INVENTION

### Summary of the Invention

CNT reinforced concrete formed with the aid of plasticizers has been discovered to have increased strength properties. It has been found through experimental studies that use of at least about 0.2% by weight CNT in combination with relatively low amounts of plasticizer in otherwise conventional mixtures of cement and aggregate produces concrete with increased strength as measured by compression and modulus of rupture testing. The percentage by weight of CNT referred to throughout this disclosure is calculated on a mass basis by dividing the mass of the CNT by the total amount of cement, aggregate and water. This discovery can be implemented by, for example, preparing additive products comprising CNT and plasticizer in appropriate weight ratios for addition to conventional ready-mix concrete that contains cement and aggregate. Depending on the plasticizer chosen, it is possible to use as little as about 2% plasticizer by weight and 0.2% CNT by weight to obtain measurable strength enhancement of the cured composites.

Preferred examples of the CNT reinforced concretes of the invention include composites formed from admixture of about 0.2% by weight CNT, and about 2% by weight of a superplasticizer with a standard mixture of dried sand and Portland cement. The mixtures were prepared by adding the CNT material to the water used to hydrate the mixture, then adding the cement and the dry sand, and finally adding the superplasticizer after the other materials are at least partially admixed. Testing of samples cured under standard conditions indicated an increase in both compressive strength and modulus of rupture.

Thus, while use of CNT with cement has been previously reported, we have discovered that conventional cement/aggregate (concrete) composites (as compared to pure cement CNT mixtures previously studied) can be structurally improved providing that at least a minimum amount of CNT is used in combination with efficient plasticizers. Experiments demonstrated that the disruption in cement bonding that occurred when CNT alone was added to cement/sand mixtures could actually cause a reduction in strength compared to non CNT control samples. On the other hand, once even relatively low amounts of effective plasticizer material were added, the addition of CNT was shown to increase both the compressive strength and the modulus of rupture of the samples.

### DETAILED DESCRIPTION

This invention arose from participation of the inventors in a school sponsored science contest. The hypothesis for testing was whether or not increasing the percent by mass of CNT would increase the failure pressures both in tension and compression. To test this hypothesis a first set of experiments was designed using amounts of CNT material ranging from 0.0% to 0.3% CNT. The results of strength testing on these samples indicated no significant increases in strength and, in some instances, indications of decrease in strength. Microscopic evaluation of the samples revealed that significant amounts of voids had developed in the CNT containing samples. It was hypothesized that the presence of such voids was responsible for lack of improved strength and may also have accounted for an indication of strength reductions. It was concluded that the use of CNT alone was disrupting the hydration and cement bonding that is required to form strong cement/aggregate composites. Whatever possible value the strength and geometry of the CNT material might provide, it was apparently being negated by this disruption of cement bonding. A complete summary of the materials, procedures results and data analysis of this first set of tests is set forth below.

### Initial Testing

In the initial set of experiments, samples were prepared in accordance with ASTMC305 for the production of 1.5 liters of material. The initial samples were prepared as follows: distilled water in the amount of 391.1 milliliters was added to a mixing bowl. For the control group the next addition of material was cement. For the four (4) test groups, amorphous carbon and varying amounts of CNT's were added. In particular, a sample using 10.2452 grams of amorphous carbon added to the water was prepared. Then groups of samples at weight amounts of 0.1% CNT (3.4151 grams of carbon nanotubes), 0.2% CNTs (6.830 grams of carbon nanotubes) and 0.3% CNTs (10.2452 grams of carbon nanotubes) were added to the distilled water.

Then 806.4 grams of cement powder was added to the water and mixed at low speeds for approximately thirty seconds. Finally, 2,217.6 grams of dry sand was gradually added over thirty seconds while mixing at low speeds. The mixer was then set at medium speed for thirty seconds. After allowing the mix to sit for ninety seconds, and scraping the excess from the sides of the bowl, the mixer was again turned on to medium speed and mixed for sixty seconds.

As expeditiously as possible, molds for flexure samples were produced by distributing the cement into six (6) 40 by 40 by 160 millimeter molds. Compression samples were then produced by distributing cement into six (6) 50.8 by 50.8 by 50.8 millimeter cubes.

All the samples were allowed to set overnight at room conditions. They were then removed from the molds and cured in lime-saturated water for twenty-eight days.

In this initial experiment, the resulting data was erratic in both sets of strength testing. The control group (no additive) was measured to have an average compressional strength of 7,673 psi. The carbon control group (amorphous carbon) was slightly weaker averaging only 7,183 psi, a decrease of 6.39%. The 0.1% CNT group was slightly weaker as well, averaging 7,237 psi, a decrease of 5.69% over the control. The 0.2% CNT group was the weakest of all, averaging only 5,744 psi, a decrease of 25.14%. The 0.3% CNT sample broke the apparent trend made by the first two nanotube groups and the control, still decreasing the cement strength, but only to 6,135 psi, or by 20.05%. Variance for the results were 5.17%.

modulus of rupture tests showed a similar lack of conclusiveness. The control group was measured to have an average MOR of 1.330. The carbon control group was slightly weaker, averaging only 1.270 psi, a decrease of 4.75%. The 0.1% CNT group was slightly weaker also, though barely, averaging 1,320 psi, a decrease of 0.75% over the control. The 0.2% CNT group averaged only 1,310 psi, a decrease of 1.75%. In this test, the 0.3% CNT group continued the apparent trend made by the first two nanotube groups and the control, decreasing the cement strength more than both of the previous nanotube groups, to 1,300 psi or by 2.5%. Percent variance for this test was 7.75%.

### Revised Testing

Visual observation of these samples showed numerous voids and cracks. It was postulated that strong capillary forces of the nanotubes caused water to be drawn into them, effectively sequestering the water from the rest of the mixture and therefore causing workability to decrease. This, in turn, caused the fluid cement to not completely fill its respective mold, resulting in large bubbles of gas being trapped in the cement while curing. These bubbles and voids produced samples with uneven sides and surfaces which significantly reduced the compressive and tensile strengths.

The visual analysis of the samples from the initial testing led the inventors to set up and run a second set of tests that would address the void problem. In this second set of testing a superplasticizer was used to enhance the mixability and flow of the samples. Relatively low amounts of a super plasticizer, sold under the tradename Glenium 3400 NV, when combined with at least about 0.2% by weight CNT resulted in samples that demonstrated increased strength properties.

The general procedures outlined above for the initial set of experiments were repeated, this time using a small amount of plasticizer. The plasticizer was added after the CNT's, cement and dried sand, approximately halfway to completion of the mixing time. In this set of 1.5 liter samples, 3.18 millimeters of Glenium plasticizer was employed.

This is equal to approximately 2.3 grams/liter, based on a reported density of 1,100 grams/liter for the plasticizer. On a weight basis, the plasticizer was used in approximately 0.1% by weight, calculated on the basis of the amount of plasticizer divided by the total of the plasticizer, cement, aggregate and CNT. In this group of samples, the control group (no additions) was measured to have an average compressional strength of 8,730 psi. The carbon control group (amorphous carbon) was slightly weaker, averaging only 7,990 psi, a decrease of 8.53%. The 0.1 CNT group was slightly weaker as well, averaging 7,800 psi, a decrease of 10.63% relative to the control. However, the 0.2% CNT group increased the strength relative to the control, averaging 9,179 psi, an increase of 5.05%. The percent variance of the results as a whole was only 3.33%.

The modulus of rupture tests showed the following. The control group was measured to have an average MOR of 1,480 psi. The carbon control (amorphous carbon) group was slightly weaker, averaging only 1,460 psi, a decrease of 1.35%. The 0.1 CNT group was considerably stronger, averaging 1,580 psi, an increase of 7.22% over the control. The 0.2% CNT group also increased the MOR, but only to 1,520 psi, or by 2.93%. Percent variance for these tests was 5.17%.

The above data confirms that the tensile strength of carbon nanotubes can be used to improve strength properties of concrete. The results of the above tests show that by adding as little as 0.1% CNT by mass, can increase the tensile strength of Portland cement composites, but that same amount can reduce compressive strength. When at least about 0.2% CNT was added, there was a small amount of increase in both compressive and tensile strength capabilities of the samples. It was further recognized that the workability of the concrete that contained the CNT additives could be greatly enhanced through the use of small amounts of super plasticizers. It is believed that the combination of the enhanced workability supplied by the super plasticizers greatly aids the transmission of the inherent tensile strength of the CNTs to the composite as a whole.

1. A nanotube reinforced composite formed by hydration and curing of an admixture comprising:
(a) portland cement;
(b) at least about 0.1% of a plasticizer;
(c) at least about 0.2% by weight CNT;
(d) aggregate material.

2. A nanotube and cement mixture for forming concrete comprising:
(a) cement;
(b) plasticizer in an amount of at least about 0.1% by weight;
(c) CNT's in an amount of at least about 0.2% by weight.

3. A concrete preparation ready for mixing with water comprising:
(a) cement;
(b) aggregate;
(c) at least about 0.2% by weight CNT;
(d) at least about 0.1% by weight plasticizer.

4. A method for increasing the strength of concrete comprising:
adding to a cement and aggregate mixture at least about 0.2% by weight of CNT and at least about 0.19% by weight plasticizer.
